(19) United States
(12) Patent Application Publication
(10) Pub. No.: US 2013/0302457 A1
(43) Pub. Date: Nov. 14, 2013

(54) INJECTION-MOLDING MACHINE

(71) Applicant: ZAHORANSKY FORMENBAU GMBH, Freigurg (DE)

(72) Inventor: Ulrich Zahoransky, Freiburg (DE)

(21) Appl. No.: 13/887,586

(22) Filed: May 6, 2013

(30) Foreign Application Priority Data
May 8, 2012 (DE) 102012008939.2

(51) Int. Cl. B29C 45/10

(52) U.S. Cl. CPC B29C 45/10
USPC 425/104; 425/556; 425/547

(57) ABSTRACT

An injection-molding machine having a stack mold for producing injection-molded parts, has first and second external mold parts and a rotatably mounted central block, the external mold parts each having a distribution plate having a hot runner for the injection material, and mold cavities being formed between molding regions on inner sides of the mold plates of the external mold parts and molding regions being formed on mold plates on opposite outer sides of the central block. At least one gripper is provided. The mold plates of the external mold parts and the central block are held detachably in place. The mold plates of the external mold parts are positionable on the distribution plates to correspond to respective feed channels, and the mold plates of the central block are positionable on the central block to correspond to respective positions of the mold plates of the external mold parts.

### INCORPORATION BY REFERENCE

The following documents are incorporated herein by reference as if fully set forth: German Patent Application No.: 102012008939.2, filed May 8, 2012.

### BACKGROUND

The invention relates to an injection-molding machine having a stack mold for producing injection-molded parts, said stack mold having a first external mold part, a rotatably or pivotably mounted central block, and also a second external mold part, the external mold parts each having a distribution plate having a hot runner for the injection material and mold plates that are arrangeable on the distribution plate, and mold cavities being formed between molding regions on the inner sides of the mold plates of the external mold parts and molding regions being formed on mold plates on opposite outer sides of the central block, and having in each case at least one gripper, arranged in an offset manner with respect to the external mold parts in the rotary or pivoting direction of the central block, for removing and holding an injection-molded part or partial injection-molded part.

Numerous embodiments of such stack molds are known, in order for example to produce twice the number of injection-molded parts, for example toothbrush bodies, brush bodies generally or handle parts of razors, but also any other desired injection-molded products, for example in two planes on a single injection-molding machine. In the case of one further development of this stack mold, the central block is rotatable such that a two-component injection-molded part can be produced on an injection-molding machine in that first of all an injection preform is injection-molded in one plane, the central block or a part thereof is rotated with the injection preform into the other plane and finish-molded there. Such cubic molds are known for example from DE 101 21 691 A1. Injection-molding machines having a double cube are also already known for example from WO 2005/077637 A1 or from U.S. Pat. No. 7,081,222 B2, in which two partial injection-molded parts can be manufactured on two central blocks arranged alongside one another, said partial injection-molded parts then facing one another after rotation of the central blocks and being connected together by the closing movement of the stack mold.

A problem with the previously known injection-molding machines is that when the mold plates are changed in order to change the pattern so as to produce different injection-molded parts on the same machine, the distribution plates having the hot runners frequently also have to be exchanged, since the injection points of the different patterns are usually different. This is complicated and costly.

### SUMMARY

It is therefore the object to create an injection-molding machine of the initially mentioned type which allows the pattern to be changed in a simpler and more cost-effective manner.

The object is achieved according to the invention in that the distribution plates of the external mold parts are arranged in each case in a fixed position, in that the mold plates of the external mold parts and the mold plates of the central block are held in each case detachably on the external mold part or on the central block, in that the mold plates of the external mold parts are positionable on the distribution plates so as to correspond to their respective feed channels, and in that the mold plates of the central block are positionable on the central block so as to correspond to the respective position of the mold plates of the external mold parts.

The mold plates can in this case be produced in a manner corresponding to the desired injection points, irrespective of the configuration of the distribution plates and the hot runners thereof, which are in a fixed position and orientation on the injection-molding machine. The mold plates of the external mold parts are then oriented individually on the respective distribution plates such that the hot runners of the distribution plates and the feed channels of the mold plates are aligned with one another. In this case, differences in position between the mold plates of different patterns can occur in the horizontal and in the vertical direction.

The mold plates of the central block are oriented in a corresponding manner on the latter such that they match the respective position of the mold plate of the associated external mold part.

In this case, it is also possible for the mold plates of the second external mold part to be arranged in an offset manner with respect to the mold plates of the first external mold part. For example, the mold plates may be arranged in a vertically offset manner with respect to one another such that an overmolding can be applied to the first partial injection-molded part at a particular point.

To this end, one external mold part may in particular be configured in each case for injecting basic bodies of an injection-molded part and the other external mold part may be configured for injection-molding a further material component onto the basic body. In this way, multicomponent injection-molded parts can be produced, for example toothbrush bodies having a special handle region or generally two-colored injection-molded parts.

It may be expedient for the grippers to be mounted in a positionable manner. Not only can the grippers be adapted to the respective position of the mold plates, if the respective injection-molded parts require an exact removal position, but it is also possible for the position of (partial) injection-molded parts removed from a mold plate to be corrected by the appropriate positioning of the gripper prior to being repositioned in another mold plate.

By way of a suitable arrangement of the mold plates and appropriate positioning movements of the grippers, partial injection-molded parts can be transposed into the mold plate for the second injection-molded component in a manner offset as desired. In this way, horizontal and/or vertical position corrections are possible, as are inclined positions.

In order to be adapted to different injection-molded parts, the grippers may have releasable gripper jaws, which can be exchanged depending on the type of the respective injection-molded parts.

It may be expedient for at least one monitoring unit for monitoring injection-molded parts or partial injection-molded parts removed from the central block by way of a gripper to be provided. For example, partial injection-molded parts produced in a first injection-molding cycle can be checked using a camera. If defects are found, for example incomplete injection-molding operations, the production run can be interrupted in order to avoid the injection-molding of a second material component onto the defective partial injection-molded parts and thus unnecessary material consumption.

An advantageous embodiment provides that at least one multifunctional unit for processing injection-molded parts or partial injection-molded parts removed from the central block is provided. This multifunctional unit can undertake a multiplicity of tasks.

In particular, the multifunctional unit may be designed for attaching a functional part to an injection-molded part or partial injection-molded part, for bending a partial injection-molded part, for cooling, for keeping warm, for rotating and/or offsetting a partial injection-molded part, for coating and/or cleaning an injection-molded part or partial injection-molded part and/or for finishing an injection-molded part.

A functional part may be for example an additional item which can be entirely or partially encapsulated, for example a further plastics part, a metal part, a wooden insert, a film, an electric circuit or an RFID transponder.

A partial injection-molded part as the basic body can be bent such that the latter is under mechanical stress when a second material component is injection-molded onto it. This may be advisable in the case of closure caps.

A date code for example may also be applied. It is also conceivable to rotate a basic body, such that the latter can be inserted into the mold plate for the second material component in a manner rotated through 180°.

Once the finished injection-molded part has been removed following the second injection-molding operation, in particular a coating and/or cleaning operation can be carried out or a date code applied using the associated multifunctional unit.

The injection-molded parts or partial injection-molded parts processed on the multifunctional unit can likewise be checked using the monitoring unit.

It is expedient, in particular in the case of short injection-molding cycles, for the grippers to be in each case multiple grippers. The mold plates are usually multi-cavity molds for the simultaneous injection-molding of a plurality of injection-molded parts. The latter can be removed simultaneously from the mold plate using the multiple grippers and previously removed partial injection-molded parts can be inserted into an appropriate mold plate for the second material component.

In the case of relatively long injection-molding cycles, i.e. when more time is available for removing or inserting the (partial) injection-molded parts, it is also possible to use a single gripper or a smaller multiple gripper which can simultaneously grip in each case only some of the injection-molded parts, and the injection-molded parts are removed or inserted successively in portions.

The grippers may preferably be in each case gripping robots, in particular 6-axis robots or SCARA robots. The finished injection-molded parts can be removed from the respective mold plate by way of the grippers. However, it is also possible for ejection elements for ejecting finished injection-molded parts to be provided in each case in the region of the mold plates of the central block.

A further concept of the invention provides for the mold plates to be configured in each case for receiving cassettes that at least partially receive the injection-molded parts or partial injection-molded parts.

In this case, the cassettes can each have receiving orifices for regionally receiving clusters of bristles. This makes it possible to produce brushes having clusters of bristles encapsulated in an anchoring region, such that it is not necessary to subsequently plug the clusters of bristles into the finished brush body. In this case, the clusters of bristles inserted into the cassettes can be encapsulated with seal plates.

In a corresponding manner, it is possible in this case for the grippers to be configured to grip the cassettes, in order to insert the latter into the mold plates and to remove the cassettes, with (partial) injection-molded parts held thereon, from the mold plates.

In this case, all of the mold plates of the central block can be provided to receive the cassettes, or only the mold plates for the first partial injection-molded parts, while the latter, after removal from the respective mold plate, are separated from the cassette and introduced without the cassette into the mold plate for the second injection-molded component.

In order to open and close the injection molds, the central block may be arranged in a fixed position and the external mold parts are mounted in each case in a linearly displaceable manner.

Alternatively, one of the external mold parts may be arranged in a fixed position and the central block and the other external mold part are mounted in each case in a linearly displaceable manner.

### BRIEF DESCRIPTION OF THE DRAWINGS

Exemplary embodiments of the injection-molding machine according to the invention are explained in more detail in the following text with reference to the drawings, in which, in a partially schematic manner:

FIG. 1 shows a perspective view of an injection-molding machine according to the invention,

FIG. 2 shows an end-side view of the injection-molding machine from FIG. 1,

FIG. 3 shows a longitudinal side view of the injection-molding machine from FIG. 1,

FIG. 4 to FIG. 7 each show a perspective view of the injection-molding machine in different phases of an operating cycle,

FIG. 8 shows a perspective view of an injection-molding machine having a central block mounted on the top side and the underside, and

FIG. 9 shows a longitudinal side view of the injection-molding machine from FIG. 8.

### DETAILED DESCRIPTION OF THE PREFERRED EMBODIMENTS

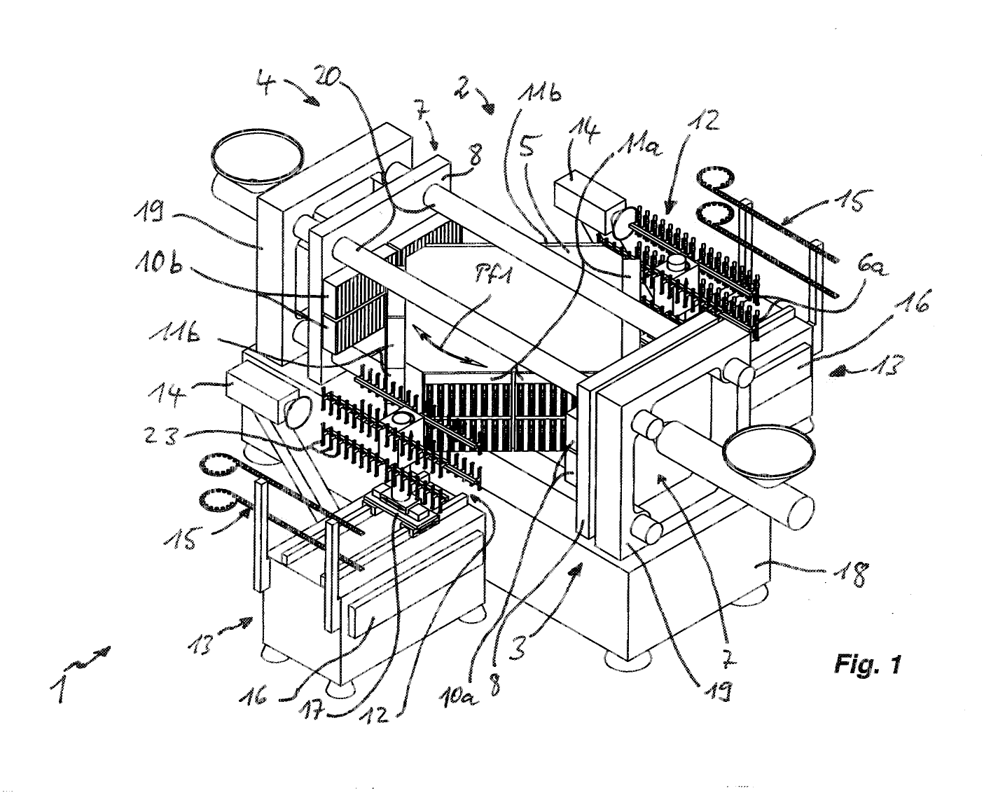

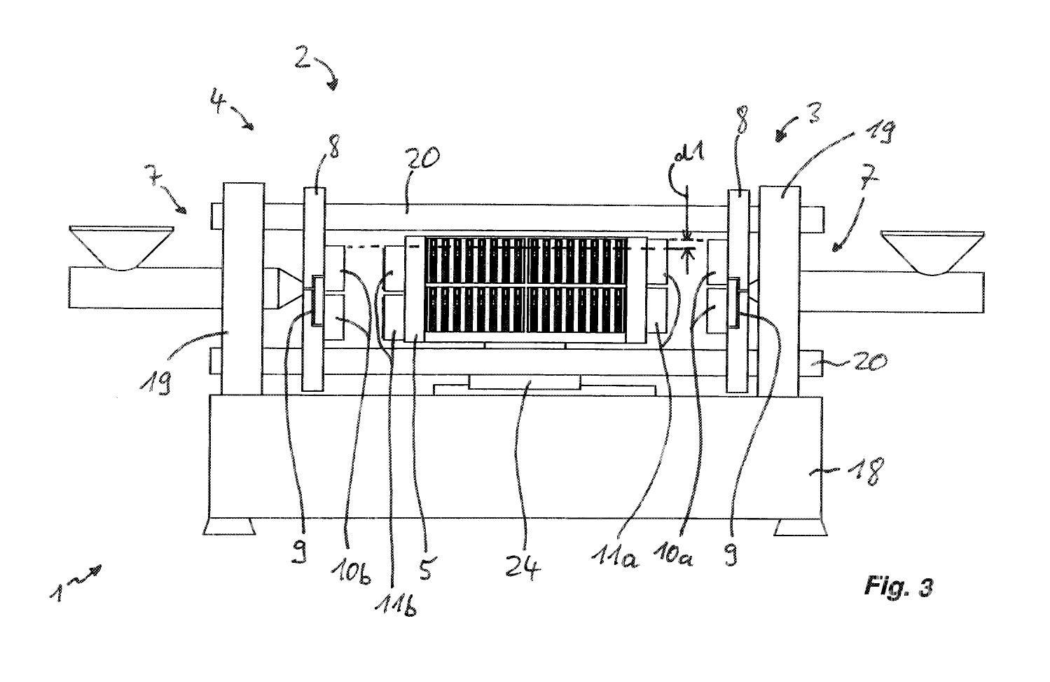

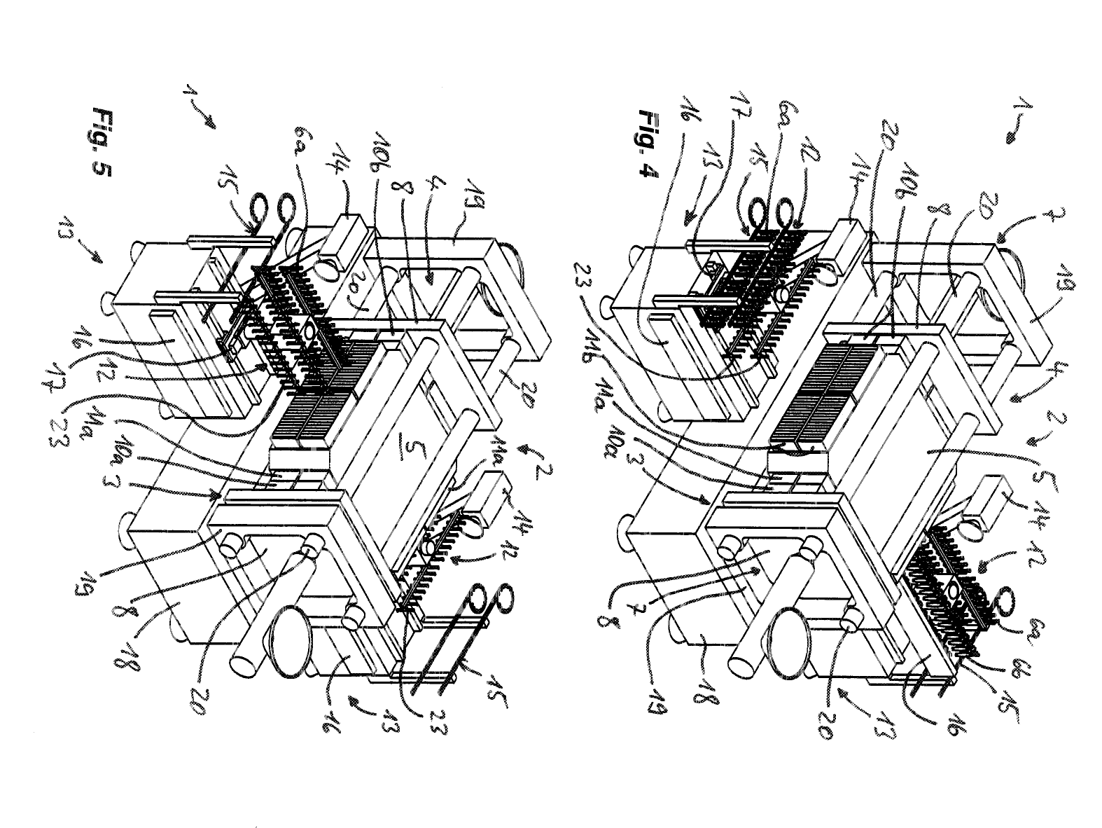

An injection-molding machine designated in its entirety with 1 has, according to FIG. 1, a stack mold 2 for producing injection-molded parts 6b. In this case, a first, fixed external mold part 3, a central block 5 and a second, movable external mold part 4 are provided. The central block 5 and the movable external mold part 4 are linearly displaceable between a closed position (FIGS. 4-7) and an open position (FIGS. 1, 3).

In the open position, the central block 5 can be pivoted about a rotation axis, wherein oscillating pivoting about in each case 90° in one direction and back in the opposite direction in the next operating cycle are provided (arrow Pf1, FIG. 1).

The external mold parts 3, 4 are each assigned an injection-molding device 7 having a distribution plate 8 having hot runners 9 (FIG. 3). In each case mold plates 10a, 10b are mounted in a releasable and positionable manner on the distribution plates 8. In a corresponding manner, mold plates 11a, 11b are mounted in a releasable and positionable manner on the central block 5, wherein in each case mold plates 10a, 11a form mold cavities for first partial injection-molded parts and mold plates 10b, 11b form mold cavities for second partial injection-molded parts or for injection-molding a second material component onto the first partial injection-molded parts.

Provided in the region of the outer free sides of the central block 5, which are arranged in an offset manner with respect to the external mold parts 3, 4 in the direction of rotation of the central block 5, is in each case a gripper 12 which is in the form of a multiple gripper and by way of which in each case partial injection-molded parts 6a or finished injection-molded parts 6b can be removed from the mold plates 11a, 11b and held.

The distribution plates 8 are arranged in each case in a fixed manner in the sense that the hot runners 9 are in a fixed position during injection-molding. The distribution plate 8 of the movable mold part 4 is movable merely in the sense of the adjustment between the open and closed positions. The mold plates 10a, 10b are in each case arrangeable on the distribution plates 8 so as to correspond to their feed channels (not illustrated). As can be seen clearly in FIG. 3, the mold plates 10a, 10b of the two external mold parts 3, 4 can be arranged so as to be offset with respect to one another. In the exemplary embodiment according to FIG. 3, the mold plates 10a, 10b of the two external mold parts 3, 4 are offset vertically with respect to one another by a difference d1. This dimension dl represents the different mounting heights of the mold plates 10a, 10b.

For better clarity, the grippers 12 are not illustrated in FIG. 3.

The associated mold plates 11a, 11b of the central block 5 are accordingly likewise arranged on the central block 5 in an offset manner with respect to one another, such that they correspond to the corresponding mold plates 10a, 10b of the external mold parts 3, 4.

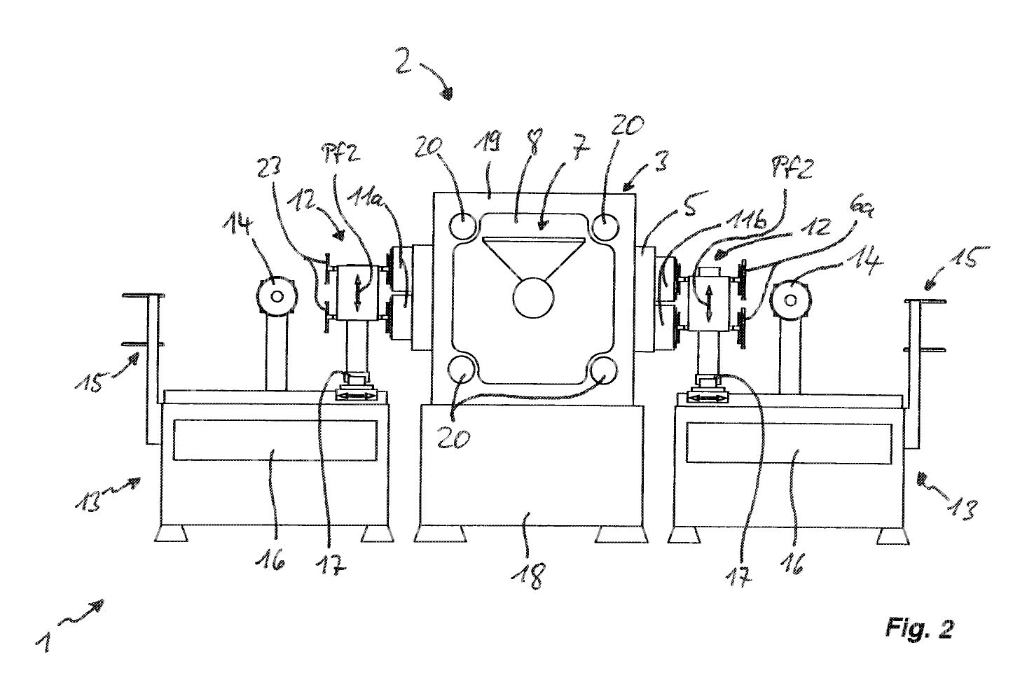

The grippers 12, too, are positionable to the same extent, this being indicated by the double arrow Pf2 in FIG. 2.

As a result of the positionability of the mold plates 11a-d, it is possible to insert the partial injection-molded parts 6a into the corresponding mold plates 11b of the central block 5 in an offset manner, without it being absolutely necessary to reposition them after removal. Thus, a second material component can be applied at a desired position on the partial injection-molded part and/or the injection-molding point of the second material component can be moved to a desired position which can be different from the injection-molding point for the first partial injection-molded part 6a.

In addition, in the event of the pattern being changed, the respective mold plates can be arranged on the distribution plates 8 so as to correspond to their present feed channels, and the associated mold plates for the central block 5 can be oriented thereon, such that different mold plates can be used on one and the same distribution plate 8 and it is not necessary to change the distribution plates 8 having the hot runners 9.

The grippers 12 are each arranged on a handling unit 13 which additionally has in each case a monitoring unit 14, a multifunctional unit 15 and a removal unit 16.

The grippers 12 are each in the form of double multiple grippers having a multiplicity of pattern-specific, exchangeable gripper jaws 23. With one side, in each case all of the partial injection-molded parts 6a of an injection-molding operation can be removed from the relevant mold plate 11a of the central block 5. With the other side of the gripper 12, in each case all of the finished injection-molded parts 6b of an injection-molding operation can be removed.

A gripper mounting 17 allows in each case the grippers 12 to be moved in a horizontal plane and vertically and also allows the grippers 12 to be rotated.

Due to the vertical orientation of the grippers 12, the latter are adapted to the respective position of the mold plates 11a, 11b, such that the respective (partial) injection-molded part 6a, 6b can be gripped at the position provided therefor.

Different types of processing operations of the partial injection-molded parts 6a or of the finished injection-molded parts 6b can take place on the multifunctional unit 15, for example they can be cooled, kept warm, cleaned, coated, bent, rotated or offset. It is also possible to apply markings or additional functional parts to the injection-molded part 6b or partial injection-molded part 6a.

By way of the monitoring unit 14, which may be for example a camera, the (partial) injection-molded parts 6a, 6b removed from the mold plates 11a, 11b or processed on the multifunctional unit 15 can be monitored, in particular for injection-molding defects or defective processing operations by the multifunctional unit 15.

Finished injection-molded parts 6b can be taken off the grippers 12 using the removal unit 16, which is illustrated only schematically. To this end, the removal unit 16 can move in each case upward and grip the injection-molded parts 6b from below and remove them.

FIGS. 4 to 7 show the injection-molding machine 1 in different phases of an operating cycle.

In FIG. 4, partial injection-molded parts 6a previously injection-molded on the front handling unit 13, in this case basic toothbrush bodies, are processed on the multifunctional unit 15. On the opposite, rear handling unit 13, finished injection-molded parts 6b, in the case of which a second material component was injection-molded onto the basic toothbrush bodies in a preceding injection-molding operation, are removed from the gripper 12 with the aid of the removal unit 16. The partial injection-molded parts 6a held on the other side of the double multiple gripper of the rear handling unit 13 are checked using the monitoring unit 14.

The partial injection-molded parts 6a checked in this way are subsequently inserted, according to FIG. 5, into the mold plates 11a, facing the rear handling unit 13, of the central block 5. On the front handling unit 13, the partial injection-molded parts 6a previously processed on the multifunctional unit 15 are checked using the monitoring unit 14.

During these processing steps, further partial injection-molded parts 6a are injection-molded in the region of the fixed external mold part 3, and molded structures are injection-molded onto the previously injection-molded partial injection-molded parts in the region of the movable external mold parts 4.

Subsequently, the movable external mold part 4 and the central block 5 travel into the open position, the central block 5 is rotated counterclockwise through 90° and the central block 5 and external mold part 4 are moved back into the closed position.

In this way, the arrangement according to FIG. 6 is reached, in which, on the front handling unit 13, the injection-molded parts 6b previously finish-molded in the region of the movable external mold part 4 are removed using the gripper 12 and then taken off the gripper 12 with the aid of the removal unit 16. On the rear handling unit 13, the partial injection-molded parts 6a previously injection-molded in the region of the fixed external mold part 4 are removed using the gripper 12 and transferred to the associated multifunctional unit 15.

Once the partial injection-molded parts 6a have been processed on the multifunctional unit 15, they are gripped again by the gripper 12 and moved in front of the monitoring unit 14 (FIG. 7) in order to be checked and monitored.

On the front handling unit 13, according to FIG. 7, the gripper 12, which is again in the form of a double multiple gripper, is rotated clockwise through 90° and the previously checked partial injection-molded parts 6a are inserted into the mold plates 11b facing the gripper 12.

A comparison of FIGS. 4 and 6 and also 5 and 7 shows that the individual processing steps proceed in the same way on the two handling units 13, in each case in a manner temporally offset with respect to one another and the two handling units 13 can thus be formed with identical structures.

In the case of the injection-molding machine 1 according to FIGS. 1 to 7, in each case one machine bed 18 having two lateral rail supports 19 and four rails 20 is provided. The movable, second external mold part 4 is mounted in a longitudinally displaceable manner on the rails 20. The central block 5 is mounted on a rotary bearing 24 which is additionally longitudinally displaceable between the open position and the closed position in order to position the central block 5 (FIG. 3).

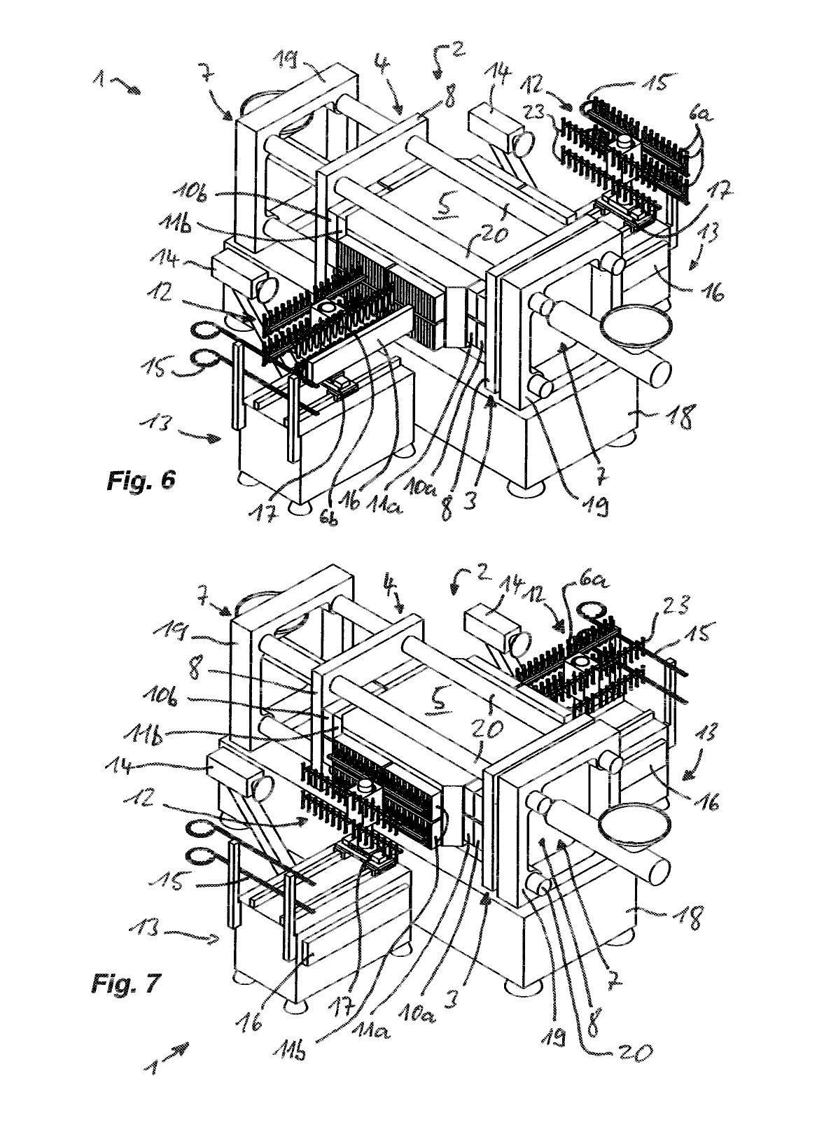

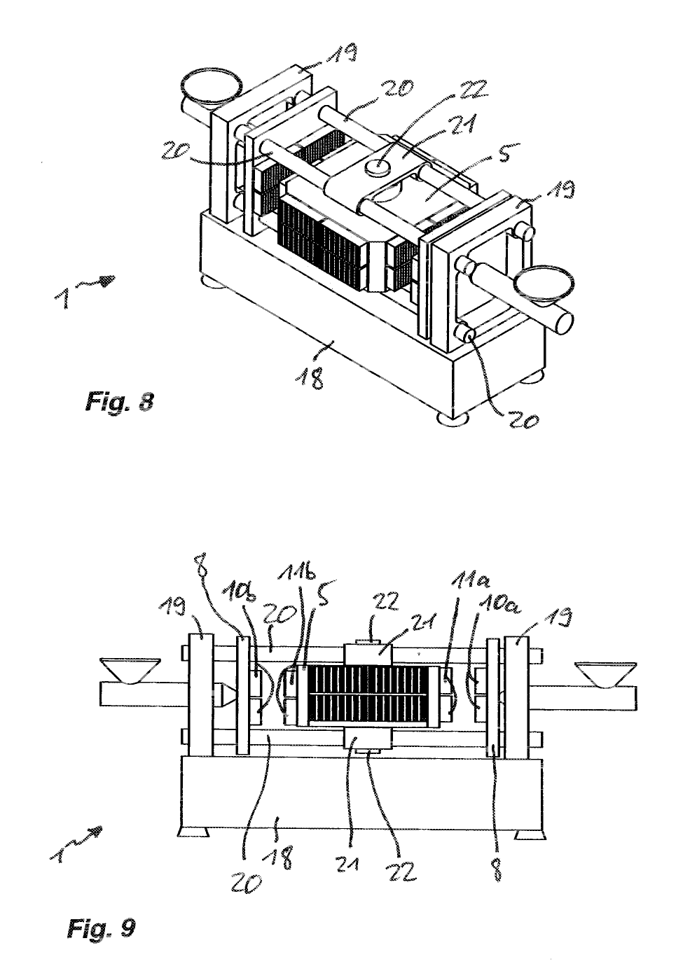

Alternatively, the central block 5, as is shown in FIGS. 8 and 9, can likewise be mounted on the rails 20. To this end, according to FIGS. 8 and 9, an upper bearing and a lower bearing 21 are provided, which are mounted in a longitudinally displaceable manner on the rails 20 and in addition each have a bearing spindle 22 on which the central block 5 is mounted in a rotatable manner.

It may also be possible to mount the central block 5 on one side such that only one of the bearings 21 is necessary.

As an alternative to the mounting with rails 20 that is illustrated in the figures, the injection-molding machine 1 can also be formed without rails.

In the region of the external mold parts 3, 4, (partial) injection-molded parts having different properties, for example a different color or material, can in each case also be injection-molded at the same time. To this end, in each case a plurality of injection-molding subassemblies can be provided on the external mold parts 3, 4.

On the other hand, it is possible for the mold plates on one side of the central block, which are arranged in each case one on top of the other in the figures, to be formed in a different manner and for example for basic brush bodies first of all to be injection-molded as first partial injection-molded parts in the lower mold plates, and for said first partial injection-molded parts subsequently to be transposed by way of the grippers into the upper mold plates of the same central block side, in order to apply a first molded structure to the basic bodies.

Subsequently, these basic bodies provided with a first molded structure can be removed from the corresponding mold plates and, after the central block has been pivoted, inserted into correspondingly formed mold plates, in order to apply a second and possibly a third molded structure. By rotating the injection-molded parts about the longitudinal axis thereof, it is thus possible to apply molded structures to different sides of the basic bodies. In this case, in each case corresponding injection-molding subassemblies should be provided on the external mold parts.

1. An injection-molding machine (1) comprising a stack mold (2) for producing injection-molded parts, said stack mold (2) having a first external mold part (3), a rotatably or pivotably mounted central block (5), and a second external mold part (4), the external mold parts (3, 4) each having a distribution plate (8) with a hot runner (9) for injection-molding material and mold plates (10a, 10b) that are arrangeable on the distribution plate (8), and mold cavities being formed between molding regions on inner sides of the mold plates (10a, 10b) of the external mold parts (3, 4) and molding regions being formed on mold plates (11a, 11b) on opposite outer sides of the central block (5), and having in each case at least one gripper (12), arranged in an offset manner with respect to the external mold parts (3, 4) in the rotary or pivoting direction of the central block (5), configured to remove and hold an injection-molded part (6b) or partial injection-molded part (6a), the distribution plates (8) of the external mold parts (3, 4) are arranged in each case in a fixed position, the mold plates (10a, 10b) of the external mold parts (3, 4) and the mold plates (11a, 11b) of the central block (5) are held in each case detachably on the external mold part (3, 4) or on the central block (5), the mold plates (10a, 10b) of the external mold parts (3, 4) are positionable on the distribution plates (8) so as to correspond to the respective feed channels, and the mold plates (11a, 11b) of the central block (5) are positionable on the central block (5) so as to correspond to a respective position of the mold plates (10a, 10b) of the external mold parts (3, 4).

2. The injection-molding machine as claimed in claim 1, wherein the mold plates (10b) of a second one of the external mold parts (4) are arranged in an offset manner with respect to the mold plates (10a) of a first one of the external mold parts (3).

3. The injection-molding machine as claimed in claim 1, wherein one of the external mold parts (3) is configured in each case for injecting basic bodies of an injection-molded part (6b) and the other of the external mold parts (4) is configured for injection-molding a further material component onto the basic body.

4. The injection-molding machine as claimed in claim 1, wherein the grippers (12) are mounted in a positionable manner.

5. The injection-molding machine as claimed in claim 1, wherein the grippers (12) have releasable gripper jaws (23).

6. The injection-molding machine as claimed in claim 1, wherein at least one monitoring unit (14) configured to monitor the injection-molded parts (6b) or the partial injection-molded parts (6a) removed from the central block (5) by the at least one gripper (12) is provided.

7. The injection-molding machine as claimed in claim 1, wherein at least one multifunctional unit (15) for processing the injection-molded parts (6b) or the partial injection-molded parts (6a) removed from the central block (5) is provided.

8. The injection-molding machine as claimed in claim 7, wherein the multifunctional unit (15) is configured to at least one of attach a functional part to the injection-molded part (6b) or the partial injection-molded part (6a), to bend the partial injection-molded part (6a), to cool, to keep warm, to at least one of rotate or offset the partial injection-molded part (6a), to at least one of coat or clean the injection-molded part (6b) or the partial injection-molded part (6a), or to finish the injection-molded part (6b).

9. The injection-molding machine as claimed in claim 1, wherein the at least one gripper (12) comprises in each case multiple grippers.

10. The injection-molding machine as claimed in claim 1, wherein the grippers (12) comprise gripping robots.

11. The injection-molding machine as claimed in claim 1, wherein ejection elements for ejecting finished injection-molded parts (6b) are provided in each case in a region of the mold plates (11a, 11b) of the central block (5).

12. The injection-molding machine as claimed in claim 1, wherein the mold plates (10a, 10b, 11a, 11b) are configured in each case for receiving cassettes that at least partially receive the injection-molded parts (6b) or the partial injection-molded parts (6a).

13. The injection-molding machine as claimed in claim 12, wherein the cassettes each have receiving orifices for regionally receiving clusters of bristles.

14. The injection-molding machine as claimed in claim 1, wherein the central block (5) is arranged in a fixed position and the external mold parts (3, 4) are mounted in each case in a linearly displaceable manner.

15. The injection-molding machine as claimed in claim 1, wherein one of the external mold parts (4) is arranged in a fixed position and the central block (5) and the other external mold part (3) are mounted in each case in a linearly displaceable manner.
